(19) United States
(12) Patent Application Publication
(10) Pub. No.: US 2009/0055727 A1
(43) Pub. Date: Feb. 26, 2009

(54) METHOD OF PERFORMING WEB-CLIPPING, A WEB-CLIPPING SERVER AND A SYSTEM FOR WEB-CLIPPING

(75) Inventors: Esben Krag Hansen, Birkerod (DK); Stefan Andreasen, Saratoga, CA (US); Martin Lindboe, Copenhagen (DK); Tobias Tobiasen, Olstykke (DK)

Correspondence Address: CANTOR COLBURN, LLP, 20 Church Street, 22nd Floor, Hartford, CT, 06103, US

(73) Assignee: KAPOW TECHNOLOGIES A/S, Hørsholm (DK)

(21) Appl. No.: 12/094,233

(22) PCT Filed: Nov. 18, 2005
(86) PCT No.: PCT/DK2005/000738

§ 371 Date: Sep. 11, 2008

(51) Int. Cl. G06F 17/00; G06F 15/14

(52) U.S. Cl. 715/234; 709/206

(57) ABSTRACT

The invention relates to a method and apparatus for performing web clipping at an intermediate clip server (ICS)—performing an intermediate rendering (VR1) by—accessing at least one source web site (SWS),—executing some or all scripts of a web document of the accessed source web site (SWS),—establishing a clip instance (CI) on the basis of said intermediate rendering (VR1)—transmitting said clip instance (CI) to a client browser (CB). According to the invention, an effective and robust web clipping has been obtained as scripts may be executed and the relevant data imported into the clip although the scripts may be external, i.e. not included in the clip as such. Moreover, the desired web clipping may be established on the basis of external links or other data external to the clip-defining HTML.

### FIELD OF THE INVENTION

This invention relates to a method of performing web clipping.

### BACKGROUND OF THE INVENTION

The World Wide Web offers several different opportunities to the world community in relation to business transactions, sharing of information, communication, etc.

A problem in the known art of Internet surfing is that only a small part of a web site may be of interest to a user.

A solution to this problem has been provided by the “web-clipping” technology. This technology provides software for cutting elements included in a web page, and subsequently inserting them into a “personal web site”. This technology typically operates by separating the HTML of the original web page into another web site or portal.

In recent years web clipping has mainly been applied for the purpose of reducing bandwidth requirements in relation to application of e.g. cordless operated PDA's or, alternatively, for the purpose of allowing the individual user to customize his personal platform principally independent of the web portal from which the web page originates.

However, one problem related to web clipping is that the web site may contain dynamic HTML (DHTML) which means that there might be scripting language such as for example JavaScript included in the HTML. When a web site like this is clipped, some of the elements will not function correctly because the HTML is drawn out of its context. For example, the JavaScript may be dependent on the structure of the HTML document, and will fail because the structure will be different in the clipped page.

### SUMMARY OF THE INVENTION

The invention relates to method of performing web clipping at an intermediate clip server (ICS)
performing an intermediate rendering (VR1) by
   accessing at least one source web site (SWS),
   executing some or all scripts of a web document of the accessed source web site (SWS),
establishing a clip instance (CI) on the basis of said intermediate rendering (VR1)
transmitting said clip instance (CI) to a client browser (CB).

According to an embodiment of the invention a web document is broadly understood as a document which may be accessed via the web. Typical and preferred examples of such web documents comprise HTML, XHTML, WML, XML, javascript, flash scripts, different plugins, text, etc. Web documents may also comprise the aforementioned types of codes or combinations thereof.

According to the invention, intermediate rendering involves a parsing into an intermediate Document Object Model (DOM) but not necessarily including a viewing or visual representation.

The invention provides an advantageous possibility of executing code or scripts of accessed web documents in the context of the original web document. In this way, web clipping may be obtained without loosing data or information contained in the web clip per se.

According to a preferred embodiment of the invention, the intermediate clip server may comprise or communicate with a portal server.

It is noted that execution of scripts are only performed, evidently, if such scripts are present in the accessed document.

According to an embodiment of the invention, an improved technique for web clipping is provided. Elements of a web page can be selected via the GUI on a user program and pasted into destination page. The invention provides a technique for clipping separate elements from a web page, and simultaneously maintain access to the original page.

According to an embodiment of the invention, an improved technique for web clipping is provided. Elements of a web page can be selected via the GUI on a user program at design time and rendered in a destination page at run time. The invention provides a technique for clipping separate elements, graphical or data elements, from a web page, and simultaneously maintain access to the original page

According to a preferred embodiment of the invention web clipping also designates web data collection and web logic integration in the sense that a clip may comprise both visual representation(s), which may be presented to the user in a modified or an unmodified state, and data extraction applicable for e.g. web data collection or web integration.

The invention may advantageously communicate with the client browser via wireless applications, web service providers, etc.

According to a further advantageous embodiment of the invention web clipping simple designates that the clipped content is visualized to a user one-to-one. Layout modification may be applied.

A client browser is generally understood as a web document interpreter such as HTML in a PC Internet Browser, UUML in a WAP browser on a mobile phone, XML browser, etc.

In an embodiment of the invention, said intermediate rendering (VR1) is furthermore updated on the basis of events at the client browser (CB).

In an embodiment of the invention, said events are established at least partially by view controller (VC) in the client browser (CB).

A view controller may according to a preferred embodiment of the invention comprise an event handler. The event handler may transform, filter or convert events established in relation to an event model as event information to the intermediate clip server. The event information may be established and transmitted in numerous different ways within the scope of the invention as long as the intermediate clip server receives sufficient information to establish the desired web clip instance.

In this context it should be noted that clip instances may comprises both a complete updated clip instance and e.g. clip update defining information. In other words, clip update defining information may offer the possibility of e.g. only transmitting information defining changes of the previous clip instance and thereby obtaining a significant reduction of data from the clip server to the client browser.

The clip instance may according to the invention be established on the basis of full or partial clipping(s) of the accessed source web site(s).

In an embodiment of the invention an intermediate clip server (ICS) performs an intermediate rendering (VR1) by
accessing at least one source web site (SWS),
parsing at least a part of a web document obtained from said source web site (SWS) into the an intermediate document object model(IDOM) and executing some or all scripts of the source web site (SWS),
establishing a clip instance (CI) on the basis of said intermediate rendering (IR)
transmitting said clip instance (CI) to a client browser (CB).

In an embodiment of the invention, said web document comprises an HTML document.

In an embodiment of the invention, said establishing of a clip instance (CI) is established by an extraction of said web document.

In an embodiment of the invention, said establishing of a clip instance (CI) involves a clipping in said web document with reference to said intermediate DOM.

According to a preferred embodiment of the invention, the desired clipping may be established in relation to the HTML code when represented with reference to a DOM, thereby enabling a robust clipping with respect to e.g. modification or changes of the source web site. When establishing the clipping with reference to a DOM-structured data representation, the source web site may be tracked more efficiently when the source web site merely modifies data and at the same time keeps the data structure constant. Alternatively, significant efforts should be made to adapt the desired clipping to the current set of data.

In an embodiment of the invention said clip instance (CI) is transmitted to the client browser (CB) via an encrypted protocol.

In an embodiment of the invention said clip instance (CI) is transmitted to the client browser (CB) via HTTP/HTTPS by small XML packets.

In an embodiment of the invention said clip instance (CI) is transmitted to the client browser (CB) by means of IP packets.

In an embodiment of the invention said web clipping is performed as a part of a continuous accessing of said at least one source web site (SWS).

In an embodiment of the invention said transmitting of said clip instance (CI) during said continuous accessing is at least partly controlled by client browser events.

According to a preferred embodiment of the invention, web clipping should enable a continuous accessing of the web source according to the clipping defined by the intermediate web server.

In an embodiment of the invention said clip instance (CI) comprises partial clip updates.

According to an embodiment of the invention, partial clip updates is applied for the purpose of reducing bandwidth usage, reducing response times, improving view update behavior in the client browser (CB), or complexity, by transmitting only changes in the clip instance during the ongoing access to the source web site.

In an embodiment of the invention said partial clip updates are transmitted as changes in said clip instance to the client browser (CB) by means of AJAX (asynchronous JavaScript and XML).

In an embodiment of the invention said clip instance (CI) defines a partial view of the accessed source web site (SWS) and wherein at least a part of said partial view is established on the basis of code executed on said intermediate clip server (ICS).

According to an embodiment of the invention code may advantageously comprises scripts contained in the accessed web document(s).

It should be noted that such execution of scripts only are performed if such scripts exist at the source web site(s), obviously.

In an embodiment of the invention said intermediate clip server is at least partially controlled by means of clip settings (CS).

According to a preferred embodiment of the invention, the clip settings may be predetermined at the intermediate clip server.

In an embodiment of the invention said clip instance (CI) comprises scripts to be executed in said client browser (CB).

In an embodiment of the invention said clip instance (CI) contains modified actions (MA) such as links, click events or browser events referring to the intermediate clip server (ICS).

According to a preferred embodiment of the invention, the established clip instance should be transmitted in a format which may result in a viewing at the client. Such format would typically be a format which may be interpreted according to a typical DOM at a client browser, thereby establishing a system which may require more or less no modification and specialized configuration at the client. In such way, any standard computer having a standard browser may benefit from the system.

Nevertheless, according to a further embodiment of the invention, the clip instance or the clip instances may be established and transmitted to the client browser in a modified state which fits in a customized way to the DOM or the configuration of the client.

In an embodiment of the invention said clip instance (CI) utilizes a view controller (VC) available to the user of the client browser for performing interactive actions between the client browser and the source web site (SWS).

In an embodiment of the invention said view controller (VC) updates the view established by the client browser on the basis of said partial clip update.

In an embodiment of the invention said view controller transmits events established in relation to an event model of the client browser (CB) as event information to the intermediate clip server.

The event information may be established and transmitted in numerous different ways within the scope of the invention as long as the intermediate clip server receives sufficient information to establish the desired web clip instance.

In an embodiment of the invention the intermediate clip server communicates with said client browser via a LAN, WAN or the Internet.

In an embodiment of the invention the intermediate clip server communicates with said at least one source web site via a LAN, WAN or the Internet.

In an embodiment of the invention said clip instance is established on the basis of clip settings established by a clip selector (CS).

According to a preferred embodiment of the invention, the intermediate clip server comprises or communicates with a clip selector which may define parts of specific sites which is intended to be clipped. Moreover, the clip selector may invoke a modification of the layout of the clipping, modification of logos, colors, etc., provide automatic authorization, authentication or other automatic functionality to the clip and modify, delete or add functionality of the clipped documents, e.g. removal of buttons etc.

In an embodiment of the invention said establishing of a clip instance (CI) is established by an extraction and modification of said web document.

In an embodiment of the invention said intermediate rendering is performed by a reentrant web browser.

According to a preferred embodiment of the invention, the intermediate rendering may be performed by a reentrant browser thereby facilitating a true multi-client system. Such reentrant web browser is capable of handling several browser states at the same time. The web browser may or not have a graphic or visual rendering.

In an embodiment of the invention said intermediate clip server (ICS) transforms and combines data in a clip applicable for data collection and logic integration.

According to a further advantageous embodiment of the invention the intermediate clip server may be applied to support data collection and logic integration of the accessed data web sources. Such data collection and logic integration should typically require a transformation which allows a client to interpret and apply the obtained data in the desired context, e.g. reports, personalized databases, etc.

Moreover, the invention relates to a system comprising at least one source web sites (SWS) an intermediate clip server (ICS) and at least one client (CL) comprising a client browser (CB), wherein said system performs the method according to any of the claims 1 to 24.

### BRIEF DESCRIPTION OF THE DRAWINGS

The invention will now be described with reference to the drawings of which

FIG. 1A illustrates a web-clipping system according to an embodiment of the invention,

FIG. 1B illustrates a web-clipping system according to a further embodiment of the invention,

FIG. 2 illustrates some basic functionalities of an embodiment of the invention in a flowchart and

FIG. 3 illustrates a more detailed embodiment of the invention.

### DETAILED DESCRIPTION OF THE PREFERRED EMBODIMENT

As used herein, use of the following terms refers or relates to aspects of the invention as described below.

The expression “web clipping” refers to any segment of a web page that can be isolated. It is a technology for cutting elements included in a web page.

The expression “user” includes any person who acts either on behalf of themselves or an entity and manipulates a client device in such a way so as to gain access to the Internet and add to, delete, resize, reposition or in other ways manipulate a web page or portions thereof.

The expression “web page” includes a display of information that can be accessed by visiting a web site. Such pages generally (but not necessarily) include one or more hyperlinks to other parts of the page or other pages. In a preferred embodiment, the web pages can be selected by a user from an index of web pages. In other embodiments, the user can select the web page without referring to an index.

The expression “web site” is a set of web pages, usually including a homepage, generally located on the same server, and prepared and maintained as a collection of information by a person, group, or organization. There is no particular requirement that a web site must be an individual device. A web site can be a single device, a set of cooperating devices, a portion of a device, or some combination thereof. It also refers to a commercial, corporate or personal location, on the World Wide Web.

The expression “web browser” is a software application that enables a user to display and interact with HTML documents hosted by web servers or held in a file system. Popular browsers available for personal computers include e.g. Microsoft Internet Explorer, Mozilla Firefox, Opera, Netscape, Safari and Konqueror. The largest networked collection of linked documents is known as the World Wide Web.

A Document Object Model is an interface that will allow programs and scripts to dynamically access and update the content, structure and style of documents. The document can be further processed and the results of that processing can be incorporated back into the presented page.

The descriptions of these terms are not intended to be limiting, only descriptive. Other and further applications of the invention, including extensions of these terms and concepts, would be clear to those of ordinary skill on the art after perusing this application.

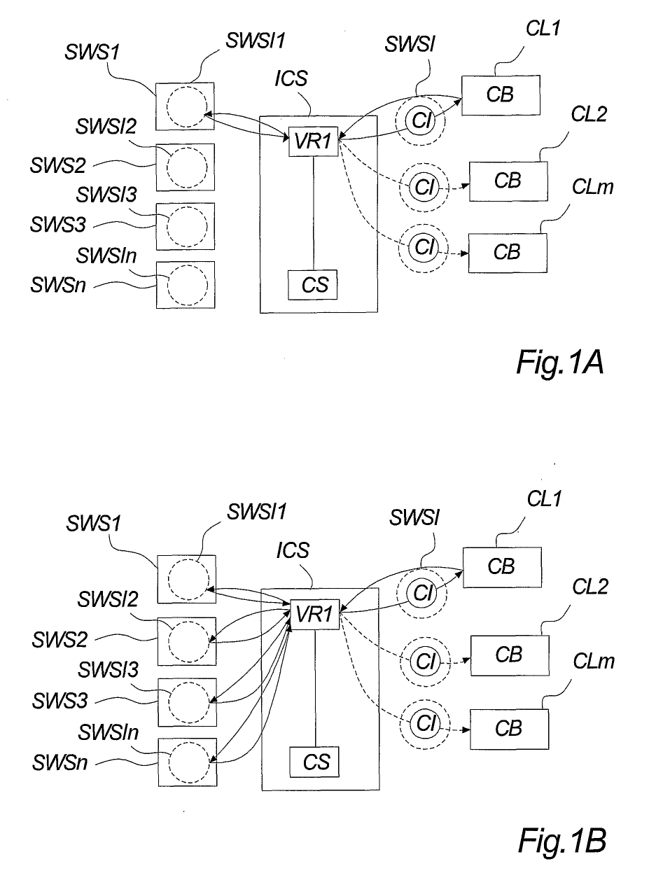

FIG. 1A illustrates a web clipping system according to an embodiment of the invention.

The web clipping system comprises a number of source web sites SWS1, SWS2, SWS3, SWSn.

These web sites SWS1, SWS2, SWS3, SWSn communicate with an intermediate clipping server ICS via the Internet or e.g. via a local area network (LAN).

The clipping server ICS communicates with a number of clients CL1, CL2, CLm via the Internet or e.g. via a LAN.

A client CL1, CL2, CLm may access one or several of the source web sites SWS1, SWS2, SWS3, SWSn via the intermediate clip server ICS.

The intermediate clip server ICS established a clip by means of a clip selector CS. The clip settings established by the clip selector CS may be individual to the different clients CL1, CL2, CLm or may be shared by a group or a subset of the clients CL1, CL2, CLm.

The clip selector CS defines which parts of a source web site SWS1, SWS2, SWS3, SWSn that the intermediate clip server delivers to the individual client or group(s) of these.

The clip selector CS may be located in connection with the intermediate clip server ICS as illustrated but it may also be located at the individual clients CL1, CL2, CLm.

As an example of a web clipping a client CL1 requests a clipped access to source web site SWS1. The complete representation of the source web site SWS1 is referred to as a source web site instance SWSI and this instance is navigated or browsed by the clip server ICS at least enough to establish the client-requested clipping instance. A typical way of requesting e.g. updates of a clipping instance may be establishment of events at the client browser (CB) The intermediate clip server ICS performs a virtual rendering VR1 of the content of the accessed source web sites SWS1 and establishes and outputs a clipping instance CI which is passed to the client CL1 via the Internet, WAN or a LAN.

The clipping instance CI may—as indicated in the present figure—originate from one web source SWS1 only—or evidently from several web sources. Thus, in the illustrated embodiment, the clip instance comprises a complete or a partial instance of a source web site instance SWSI1.

As indicated in the drawing, a web clipping instance CI will typically comprise a subset of the complete available source web site instance SWSI.

For reasons of explanation, the illustrated clip selector CS chooses one clip CI from one source web site and delivers the same clip instance to all clients. Evidently, the clip selector may combine different clip instances from different source web sites and deliver these to a client which according to the predefined clip settings request clipping instances from different source web sites.

FIG. 1B illustrates a further embodiment of the invention where a number of source web sites SWS1, SWS2, SWS3, SWSn are accessed at the same time in order to establish a clipping combined from these sites.

In the illustrated embodiment the clip instance is obtained as a combination of instances SWSI1, SWSI2, SWSI3, SWSIn from different web sources.

With reference to the above-mentioned FIGS. 1A and 1B it should be noted that the obtained clip instance(s) CI may be transmitted to a single client such as CL1 or to a group of clients, e.g. all the illustrated clients or a subset of these.

An advantage of sharing clip instances CI or at least intermediate DOM—e.g. associated with relevant script states, window structures etc. between different requesting clients is that web sites according to this specific embodiment of the invention is that the predefined clips may be associated with one or a plurality of predefined intermediate DOM'S, relevant script states, window structures etc. representing the designated source web sites or instances of these sites and thereby ensuring that access to the current data of the relevant source web sites upon request from a client may be obtained virtually with no or very little delay.

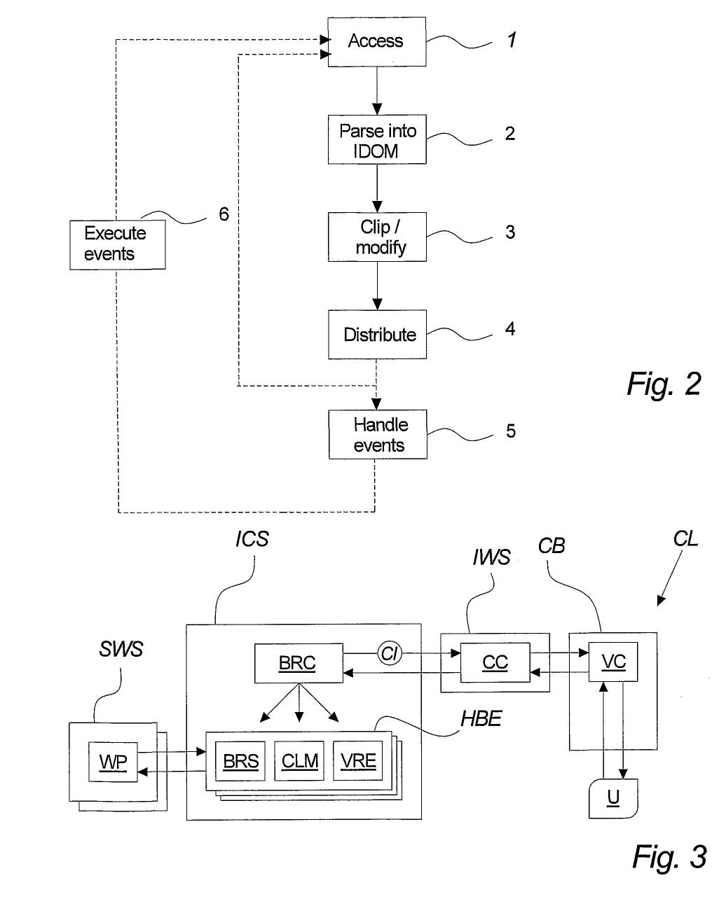

FIG. 2 illustrates a flowchart of a clipping performed and distributed by an intermediate clip server according to an embodiment of the invention.

In step 1, Access, an intermediate clip server accesses a specified source web site. The access may be initiated or triggered according to predefined access routines or upon a request from a client computer.

In step 2, Parse into IDOM, the document obtained by the source web site is parsed into an intermediate document object model IDOM and all clip-relevant scripts are executed in order to obtain the desired a virtual rendering of the source web site. It is noted that the virtual rendering, also referred to as an intermediate rendering, may or may not involve a specific visual rendering. Typically, such visual rendering would be omitted. The execution may be complete or at least enough to provide the desired clip instance(s) to the client. According to a preferred embodiment of the invention, an execution of some or all scripts will be performed at the intermediate server. Moreover, it should be noted that it is possible to include some scripts or at least parts of the scripts in the clips instance which may subsequently be submitted to the client browser for local execution of these.

In step 3, Clip/Modify, the resulting clip instance of the parsed document(s) is/are modified according to clip settings into the desired clip instance. The clip settings are preferably predefined. It should be noted that a clip instance may be formed by one or several source web documents. The modification is preferably performed with reference to the document object model related to the accessed document as such modification is much more robust than a modification made with reference to the HTML itself.

Such robustness may e.g. result in minor changes in data of the source web site and will only result in the corresponding data changes at the browser of the client with a minimized risk of clip-setting invalidation caused by data changes.

The resulting clip instance may e.g. comprise the relevant clipped HTML data—modified and adapted as necessary—, modified links, active scripts, references to links buttons etc.

Such references to scripts or buttons may allow the user of a client browser to interact with the virtual rendering at the intermediate clip server.

The clip settings may preferably be predefined with reference to the intermediate DOM in order to facilitate an easy and fast access to the data of a source web site when a clip of a web source is requested.

In step 4, Distribution, the obtained clip instance is distributed to one or more relevant client computers ready for rendering at the client browser.

Basically, all steps 1 to 3 may be run prior to any request from a single client or they may be executed on a specific request.

One way of performing an efficient web clipping according to the invention is to prepare an initial clip instance related to the specific requesting client and the requested source web site.

The following steps are to be regarded optional in the sense that a handling of events are not mandatory to each realization of access and parse into IDOM as explained in step 1 and step 2. Access may thus be obtained, as previously described as a self triggered process during some time of the access and some times as a result of events in a client browser. This is illustrated by the dotted feed-back paths of the flowchart of FIG. 2.

In step 5, Handle events, event obtained from a view controller of the client browser. The view controller, see FIG. 3, detects events performed by a user and converts these events into event representing data which may be submitted to the intermediate clip server ICS, see FIG. 1 and 3.

The handle events step may furthermore filter or modify the event in order to obtain a desired filtering, e.g. ignoring specific events, adding events and functionality or e.g. simply convert the registered events into event representing data suitable for the virtual intermediate rendering.

In other words, this step performed by the view controller enables that events may be transmitted from the client browser to the intermediate clip server and enable such events to be executed, e.g. by parsing into the intermediate DOM of the intermediate clip server ICS.

In step 6, Execute events, the intermediate clip server ICS may then execute the events in their original context and update the clip instance. The update clip instance may subsequently be transmitted to the client browser in full or as a partial update.

Different repeat and bypass loops may be added to the flowchart within the scope of the invention.

A view controller is explained in a more details with reference to FIG. 3 below.

FIG. 3 illustrates a further and more detailed embodiment of the invention.

The system comprises at least one source web site SWS comprising a number of web pages WP. The web site is connected for two-way communication with an intermediate clip server ICS.

The intermediate clip server ICS comprises a browser-controller BRC controlling a browser engine HBE.

The browser engine HBE comprises the browser state BRS related to a source web site, a clip manager CLM and a virtual rendering engine VRE.

The intermediate clip server ICS is connected for two-way communication with an intermediate web server IWS.

The intermediate web server IWS is again connected for two-way communication with a client CL such as a conventional personal computer.

A client browser CB of the client CL may be operated by a user U and comprises a view controller VC controlling current clip instances of the client browser CB. The view controller is a program that may be included in and transmitted with the clip instance and automatically implemented in the client browser CB. Thus, standard browsers may be applied at the client CL.

The above-disclosed system features automated browsing of web sites SWS in order to provide functional Application Program Interface (API) access or web clipping of one or more source web sites (SWS) in a client browser CB through the portal web server IWS.

Thus, the user U may request a view from the web or portal server IWS. If the view contains a clip, the communications controller CC on the portal server IWS requests the appropriate clip CI from a browser controller BRC on the intermediate clip server ICS. The browser controller BRC spawns a browser engine HBE that can load one or several source web pages WP and create an appropriate virtual view, in the form of a browser state BRS, of the page using a virtual rendering engine VRE. The virtual view will typically, but not necessarily, be a non-visual view without any graphic rendering. As part of this, the browser controller BRC may have been configured to perform automatic navigation and interaction with the source web site SWS, such as automatic login on the source web site, without the user necessarily being aware of this. The clip manager CLM decides which part(s) of the virtually rendered page that is communicated back to the client browser CB according the clip settings. The part(s) of the web page WP which is communicated is called a clip instance CI. Once loaded in the client browser CB the clip may contain links that can be clicked on or other potential actions that the user U may perform. If such events or actions occur the view controller VC in the client browser CB will communicate the relevant events or actions as well as the view context to the communications controller CC on the web/portal server IWS which in turn will request a clip update from the browser controller BRC on the intermediate clip server ICS. The browser controller BRC will typically obtain the update by emulating or performing the events or actions on the browser state BRS for that particular user session and source web site. This ensures that the events or actions are emulated or performed in the context of the source web site, not the clipped context in the client browser CB. The result of emulating or performing the events or actions is an updated browser state BRS reflecting the results of the events/actions. From the updated browser state BRS, a new clip instance CI is created and sent, as a partial or full update, to the client browser CB. The update may preferably be sent as a differential update minimizing the required bandwidth, reducing response time, and improving the visual update behavior in the client browser. The communication between the intermediate clip server ICS and the communications controller CC in the intermediate web server IWS uses a suitable protocol and representation, such as HTTP/HTTPS as the protocol and XML as the representation. The communication between the view controller VC in the client browser CB and the communications controller CC also uses a suitable protocol and representation, such as HTTP/HTTPS and XML. The view controller VC may use AJAX (Asynchronous JavaScript and XML) as the method for communicating with the communications controller CC and updating the views in the client browser.

1. Method of performing web clipping at an intermediate clip server comprising:
performing an intermediate rendering by
accessing at least one source web site,
executing some or all scripts of a web document of the accessed source web site,
establishing a clip instance on the basis of said intermediate rendering
transmitting said clip instance to a client browser.

2. Method of performing web clipping according to claim 1, wherein said intermediate rendering is furthermore updated on the basis of events at the client browser.

3. Method of performing web clipping according to claim 1, wherein said events are established at least partially by view controller in the client browser.

4. Method of performing web clipping according to claim 1, at an intermediate clip server
performing an intermediate rendering by
accessing at least one source web site,
parsing at least a part of a web document obtained from said source web site into the an intermediate document object model(IDOM) and executing some or all scripts of the source web site,
establishing a clip instance on the basis of said intermediate rendering
transmitting said clip instance to a client browser.

5. Method of performing web clipping according to claim 1, wherein said web document comprises an HTML document.

6. Method of performing web clipping according to claim 1, wherein said establishing of a clip instance is established by an extraction of said web document.

7. Method of performing web clipping according to claim 1, wherein said establishing of a clip instance involves a clipping in said web document with reference to said intermediate DOM.

8. Method of performing web clipping according to claim 1, wherein said clip instance is transmitted to the client browser via an encrypted protocol.

9. Method of performing web clipping according to claim 1 wherein said clip instance is transmitted to the client browser via HTTP/HTTPS by small XML packets.

10. Method of performing web clipping according to claim 1, wherein said clip instance is transmitted to the client browser by means of IP packets.

11. Method of performing web clipping according to claim 1, wherein said web clipping is performed as a part of a continuous accessing of said at least one source web site.

12. Method of performing web clipping according to claim 1, wherein said transmitting of said clip instance during said continuous accessing is at least partly controlled by client browser events.

13. Method of performing web clipping according to claim 1, wherein said clip instance comprises partial clip updates.

14. Method of performing web clipping according to claim 1, wherein said partial clip updates are transmitted as changes in said clip instance to the client browser by means of AJAX (asynchronous JavaScript and XML).

15. Method of performing web clipping according to claim 1, wherein said clip instance defines a partial view of the accessed source web site and wherein at least a part of said partial view is established on the basis of code executed on said intermediate clip server.

16. Method of performing web clipping according to claim 1, wherein said intermediate clip server is at least partially controlled by means of clip settings.

17. Method of performing web clipping according to claim 1, wherein said clip instance comprises scripts to be executed in said client browser.

18. Method of performing web clipping according to claim 1, wherein said clip instance contains modified actions such as links, click events or browser events referring to the intermediate clip server.

19. Method of performing web clipping according to claim 1, wherein said clip instance utilizes a view controller available to the user of the client browser for performing interactive actions between the client browser and the source web site.

20. Method of performing web clipping according to claim 1. Method of performing web clipping according to claim 1, wherein said view controller updates the view established by the client browser on the basis of said partial clip update.

21. Method of performing web clipping according to claim 1 wherein said view controller transmits events established in relation to an event model of the client browser as event information to the intermediate clip server.

22. Method of performing web clipping according to claim 1, wherein the intermediate clip server communicates with said client browser via a LAN, WAN or the Internet.

23. Method of performing web clipping according to claim 1, wherein the intermediate clip server communicates with said at least one source web site via a LAN, WAN or the Internet.

24. Method of performing web clipping according to claim 1, wherein said clip instance is established on the basis of clip settings established by a clip selector.

25. Method of performing web clipping according to claim 1, wherein said establishing of a clip instance is established by an extraction and modification of said web document.

26. Method of performing web clipping according to claim 1, wherein said intermediate rendering is performed by a reentrant web browser.

27. Method of performing web clipping according to claim 1, wherein said intermediate clip server transforms and combines data in a clip applicable for data collection and logic integration.

28. System comprising at least one source web sites an intermediate clip server and at least one client comprising a client browser, wherein said system performs the method according to claim 1.

29. Intermediate clip server comprising means for performing an intermediate rendering by
accessing at least one source web site,
executing some or all scripts of a web document of the accessed source web site (SWS),
means for establishing a clip instance on the basis of said intermediate rendering
and means for transmitting said clip instance to a client browser.

30. Intermediate server according to claim 26, wherein said server performs an intermediate rendering according to the method comprising:
performing an intermediate rendering by
accessing at least one source web site,
executing some or all scripts of a web document of the accessed source web site,
establishing a clip instance on the basis of said intermediate rendering
transmitting said clip instance to a client browser.
